(19) United States
(12) Patent Application Publication
(10) Pub. No.: US 2023/0370286 A1
(43) Pub. Date: Nov. 16, 2023

(54) V2X VEHICULAR SECURE SERVICES REGISTRATION

(71) Applicant: FORD GLOBAL TECHNOLOGIES, LLC, Dearborn, MI (US)

(72) Inventors: Sathyanarayana Chary PALAKONDA, Northville, MI (US); Ivan VUKOVIC, Birmingham, MI (US); Krishna BANDI, Farmington Hills, MI (US)

(21) Appl. No.: 17/741,862

(22) Filed: May 11, 2022

(51) Int. Cl. H04L 9/32; H04W 12/069

(52) U.S. Cl. CPC H04L 9/3263; H04W 12/069

(57) ABSTRACT

A secure service registration is provided. A secure connection is established between a vehicle and a management system. A service request is sent to access a V2X service to the management system, the service request including a vehicle public key. It is received, from the management system, a certificate bundle encrypted using the vehicle public key, the certificate bundle including a service public/private key pair and a certificate for accessing the V2X service. The certificate bundle is decrypted using a vehicle private key corresponding to the vehicle public key. The service public/private key pair and the certificate are used to access the V2X service.

### TECHNICAL FIELD

Aspects of the present disclosure generally relate to vehicular secure services registration approaches for use with vehicle-to-everything (V2X) communication.

### BACKGROUND

V2X allows vehicles to communicate and exchange information with other vehicles, as well as with infrastructure, pedestrians, networks, and other devices. Vehicle-to-infrastructure (V21) communication enables applications to facilitate and speed up communication or transactions between vehicles and infrastructure.

### SUMMARY

In one or more illustrative examples, a vehicle for secure service registration is provided. The vehicle includes a transceiver; and a controller programmed to utilize the transceiver to establish a secure connection with a management system, send a service request to access a V2X service to the management system, the service request including a vehicle public key of a vehicle public/private key pair, receive, from the management system, a certificate bundle encrypted using the vehicle public key, the certificate bundle including a service public/private key pair and a certificate for accessing the V2X service, decrypt the certificate bundle using a vehicle private key corresponding to the vehicle public key, and utilize the service public/private key pair and the certificate to access the V2X service.

In one or more illustrative examples, a system for secure service registration is provided. A management system is programmed to receive, from a vehicle, a service request to access a V2X service, the service request including a vehicle public key of a vehicle public/private key pair; prepare a certificate bundle including a service public/private key pair and a certificate for accessing the V2X service; encrypt the certificate bundle using the vehicle public key; and transmit the certificate bundle, as encrypted, to the vehicle responsive to the service request.

In one or more illustrative examples, a method for secure service registration is provided. A secure connection is established between a vehicle and a management system. A service request is sent to access a V2X service to the management system, the service request including a vehicle public key of a vehicle public/private key pair. It is received, from the management system, a certificate bundle encrypted using the vehicle public key, the certificate bundle including a service public/private key pair and a certificate for accessing the V2X service. The certificate bundle is decrypted using a vehicle private key corresponding to the vehicle public key. The service public/private key pair and the certificate are used to access the V2X service.

### BRIEF DESCRIPTION OF THE DRAWINGS

FIG. 1 illustrates an example system for V2X vehicular secure services registration;

FIG. 2 illustrates an example of the key establishment communication flow (i) in view of the elements of the system of FIG. 1;

FIG. 3 illustrates an example of the data flow for the key establishment communication flow (i) for the example of FIG. 2;

FIG. 4 illustrates further details of the generation of the keys that are used to perform the operations discussed herein;

FIG. 5 illustrates an example data flow for the secure channel communication flow between the vehicle and the service;

FIG. 6 illustrates an example of the vehicle performing secure channel communication flow between the vehicles and a roadside unit (RSU) of a toll roadway service;

FIG. 7 illustrates an example of the vehicle performing secure channel communication flow between the vehicles and a RSU of a merchant service;

FIG. 8 illustrates an example of the vehicle performing secure channel communication flow between the vehicles and a RSU of a parking service;

FIG. 9 illustrates an example computing device.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

Connected vehicles may use cellular vehicle-to-everything (C-V2X) or dedicated short range communication (DSRC) to support multiple customer services such as tolling and car washes, food purchase, parking, etc. To support C-V2X or DSRC customer services, a vehicle may use service-oriented security credential management system (SCMS) certificates generated by the service providers. If a customer switches from a service to a new different service, the previous service provider may block the certificates which were generated for the customer after the customer has unsubscribed. A blocked certificate list may be provided to the service locations so that the customer is confirmed to no longer be able to access that service provider.

Based on how the certificates are generated, the customer's device may be blocked. For instance, public key and private keys used during the certificate's generation for the customer may no longer be able to be used. Thus, in the situation that the customer switches service providers, the customer's device may be permanently blocked, and may be unable to participate in any C-V2X communication using the blocked public key of the device that is used for certificate generation from via device's hardware security module (HSM).

As discussed in detail herein, an improved V2X vehicular secure services registration is provided. For instance, a method and system for generating, distributing, applying and discarding service-based security certificates and associated public and private key pairs may include an on-board unit (OBU) such as a telematics control unit (TCU) requiring service and a cloud service equipped to generate public/private key pairs and certificates.

The transmitting OBU may sends a request for service to the service center and may establishing a secure communication link with the service center. The OBU may generates public and private key without using the HSM of the vehicle, and may attach the public key along with a service request. Responsive to receiving a subscription request, the service center may generate private/public key pairs along with the certificate bundle, may encrypt the bundle with the received vehicle public key, and may transmits the encrypted data over the established secure channel to the OBU.

To generate device certificates, instead of using the vehicle HSM private and public key, the service provider may will generate a private key and public key and service certificates and push them to the vehicle. The OBU may receive the certificate bundle and decrypt the bundle with the vehicle private key which is generate during the service registration. The OBU may store the keys and the certificates for use when the vehicle is communicating with infrastructure of the service.

The service center may communicate the public key to all service participating infrastructure access points when the transmitting OBU opts out of services or is no longer the customer for a particular service. The service provider may create list of unsubscribed certificate list and update to each service center. The proposed solution may accordingly leverage connected vehicles features to have registration customer services more securely, and avoids issues with the HSM of the vehicle being blacklisted.

In this proposed solution customer can register multiple connected services. Each service center RSU may verify each received message against the unsubscribed certificate list such that if a message is received with these certificates, the RSU may generate a misbehavior report (MBR) and update authorities. Customer can subscribe to any other service without using the vehicle HSM keys, as the vehicle uses service provider keys and certificate bundles for service communication.

The registration allows flexibility to customers to choose different service providers. If a customer unsubscribes to a service feature, the vehicle may still be able to participate in other C-V2X communications for other services. This approach avoids the vehicle becoming blacklisted from all services by unsubscribing to a single service. Further aspects of the V2X vehicular secure services registration are discussed in detail herein.

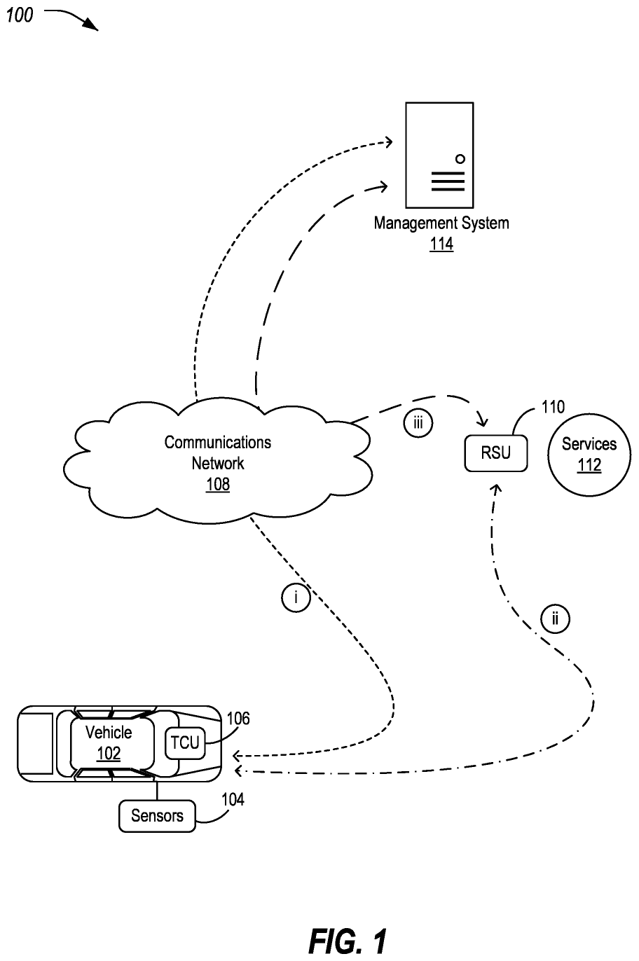

FIG. 1 illustrates an example system 100 for V2X vehicular secure services registration. As shown, the system 100 includes a vehicle 102 equipped with a TCU 106 which implement V2X functionality. The system 100 further includes a RSU 110 that also implement V2X functionality. A backend management service 114 is also included, which is configured to perform computations and recordkeeping operations. It should be noted that the system 100 is merely an example, and systems 100 having more, fewer, and different arrangements of elements may be used. For instance, one or more of the RSU 110 and backend management service 114 may be combined into a single device. Moreover, while only one vehicle 102 and one RSU 110 in connection with one service 112 is shown, it is contemplated that systems 100 would include many vehicles 102, RSUs 110, and services 112.

The vehicles 102 may include various other types of passenger vehicles, such as sedans, crossover utility vehicles (CUVs), vans, sport utility vehicles (SUVs), trucks, recreational vehicles (RVs), scooters, drones, or other mobile machines for transporting people or goods. In many cases, the vehicle 102 may be powered by an internal combustion engine. In such cases, the fuel source may be gasoline or diesel fuel. As another possibility, the vehicle 102 may be a hybrid electric vehicle (HEV) powered by both an internal combustion engine and one or more electric motors, such as a series hybrid electric vehicle (SHEV), a parallel hybrid electric vehicle (PHEV), or a parallel/series hybrid electric vehicle (PSHEV). As yet a further possibility, the vehicle 102 may be an electric vehicle (EV) powered by electric motors without an internal combustion engine. As the type and configuration of vehicles 102 may vary, the capabilities of the vehicles 102 may correspondingly vary. As some other possibilities, vehicles 102 may have different capabilities with respect to passenger capacity, towing ability and capacity, and storage volume. For title, inventory, and other purposes, the vehicle 102 may be associated with a unique identifier, such as a vehicle identification number (VIN).

The vehicle 102 generally includes multiple sensors 104 that are used to operate various aspects of the vehicle 102. These sensors 104 may be connected to onboard vehicle 102 controllers that keep track of and compute various useful data items from the sensor inputs. This sensor data may include, as some non-limiting examples: absolute location and coordinates (e.g., location as determined according to a global national satellite system (GNSS)), location relative to the map and specific roads, location relative to a certain lane, vehicle size, vehicle weight, number of axles, and number of passengers. It should be noted that the vehicle 102 may additionally or alternately use dead-reckoning, e.g., via controller-area network (CAN) or other on-vehicle messages) to estimate the location of the vehicle for road usage when GNSS is unavailable (such as in downtown areas, urban canyons, or parking structures that may block GNSS signals). If positioning information is still unavailable, the vehicle 102 may log an error time and last known location, which may be collected and used to troubleshoot difficult areas.

The TCU 106 may be configured to provide telematics services to the vehicle 102. These services may include, as some non-limiting possibilities, navigation, turn-by-turn directions, vehicle health reports, local business search, accident reporting, and hands-free calling. The TCU 106 may, accordingly, be configured to communicate over various protocols, such as with a communications network 108 over a network protocol (such as Uu). The TCU 106 may, additionally, be configured to communicate over a broadcast peer-to-peer protocol (such as PC5), to facilitate C-V2X communications with devices such as the RSU 110. It should be noted that these protocols are merely examples, and different peer-to-peer and/or cellular technologies may be used.

The communications network 108 may provide communication services, such as packet-switched network services (e.g., Internet access, voice over Internet Protocol (VoIP) communication services), to devices connected to the communications network 108. An example of a communications network 108 is a cellular telephone network. For instance, the TCU 106 may access the cellular network via connection to one or more cellular towers. To facilitate the communications over the communications network 108, the TCU 106 may be associated with unique device identifiers (e.g., mobile device numbers (MDNs), Internet protocol (IP) addresses, etc.) to identify the communications of the TCU 106 on the communications network 108 as being associated with the vehicle 102.

The RSU 110 may be a device with processing capabilities and networking capabilities, and may be designed to be placed in proximity of a service 112 for use in communicating with vehicles 102. In an example, the RSU 110 may include hardware configured to communicate over the broadcast peer-to-peer protocol (such as PC5), to facilitate C-V2X communications with the vehicles 102. The RSU 110 may, accordingly, be able to communicate with multiple vehicles 102 along a specific roadway or in a specific area. The RSU 110 may also have wired or wireless backhaul capability to allow for communication with other elements of the communications network 108, such as the backend management service 114.

The backend management service 114 may include one or more networked computing devices configured to perform operations in support of the functionality of the RSU 110. In an example, the backend management service 114 may be in communication with the RSU 110 over the communications network 108.

The system 100 may support a key establishment communication flow between the vehicles 102 and the backend management service 114. This communication flow is shown in the system 100 as flow (i) and is represented as a short-dashed line. The system 100 may also support a secure channel communication flow between the vehicles 102 and the RSUs 110. This communications flow is shown in the system 100 as flow (ii) and is represented by a dash and dotted line. The system 100 may also support a backend communication flow between the RSUs 110 and the backend management service 114. This communications flow is shown in the system 100 as flow (iii) and is represented by a long-dashed line. Further aspects of the operation of the backend management service 114 and the flows (i), (ii), and (iii) are discussed in detail herein.

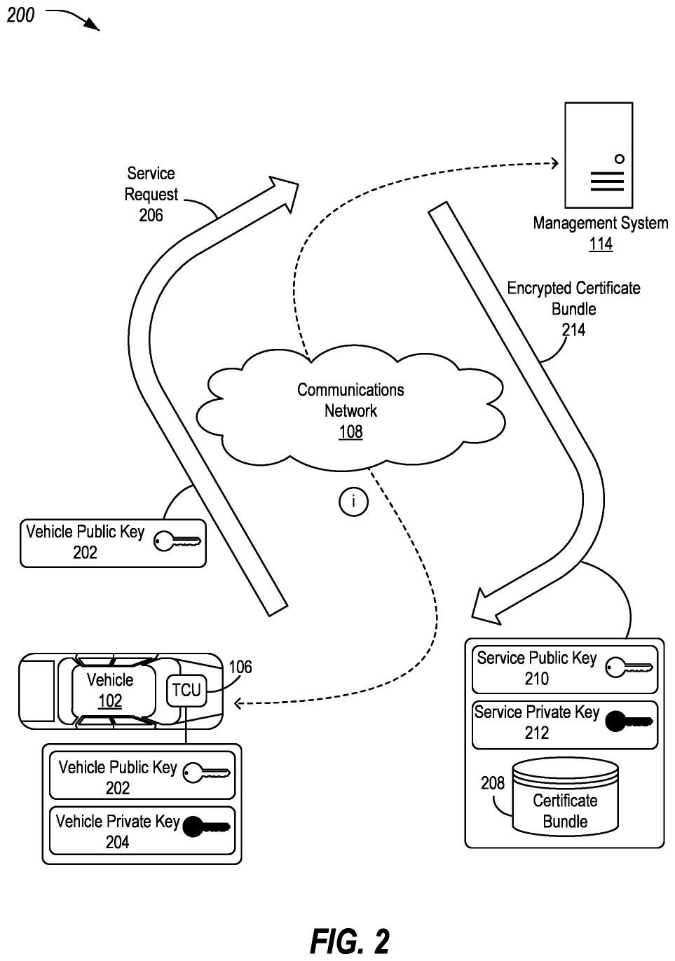

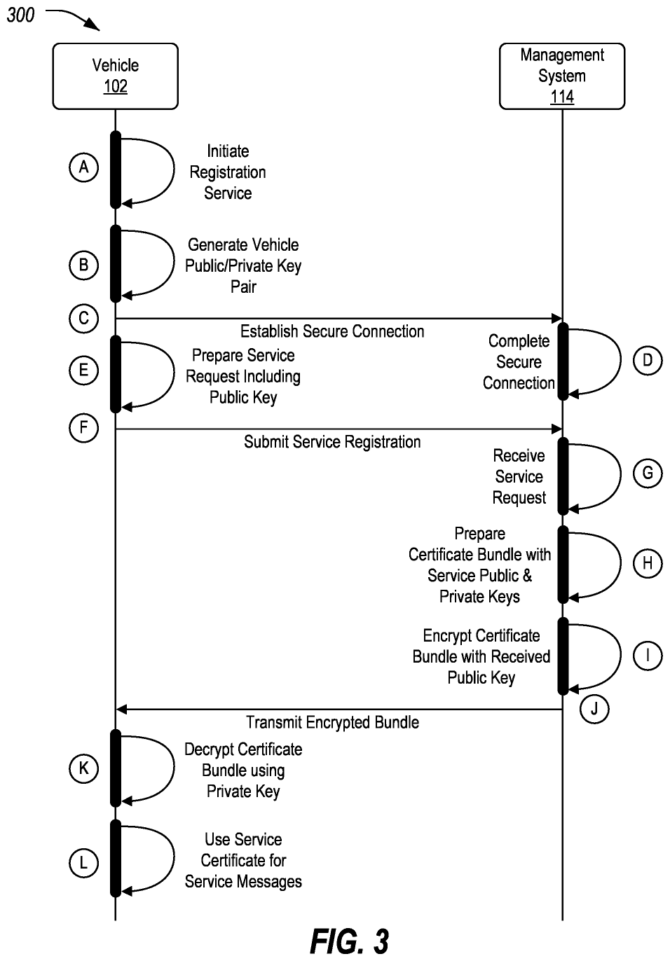

FIG. 2 illustrates an example 200 of the key establishment communication flow (i) in view of the elements of the system 100. FIG. 3 illustrates an example of a data flow 300 for the key establishment communication flow (i). With reference to FIGS. 2 and 3, at index (A) a registration service is initiated. In an example, the flow (i) may be initiated at some time before the vehicle 102 requires use of a service 112. In another example, the vehicle 102 may utilize its sensors 104 to determine that a RSU 110 in control of a service 112 is in vicinity of the vehicle 102 and may initiate the flow (i) responsive to desire to utilize the detected service 112.

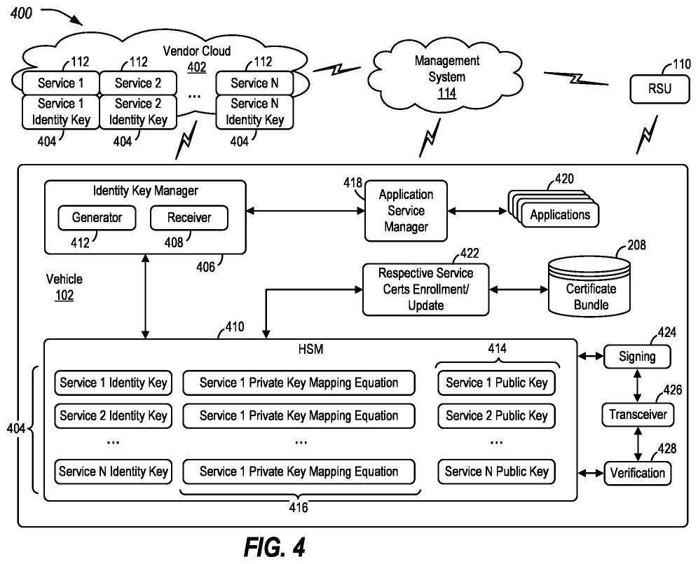

At index (B), the vehicle 102 generates a public/private key pair. This is shown in the example 200 as vehicle public key 202 and vehicle private key 204. These keys may be generated by the TCU 106 of the vehicle 102, instead of providing the private key of the HSM 410 of the vehicle 102 (discussed in further detail below). This may be avoided as the vehicle public key 202 and vehicle private key 204 pair is more easily revokable than other approaches that are more tied to a specific HSM 410. Further aspects of the key generation are shown in FIG. 4.

At index (C), the vehicle 102 initiates establishment of a secure connection with the backend management service 114. This connection request may be sent over the communications network 108 in an example. The backend management service 114 may receive the request at index (D) and may complete the establishment of the secure connection to the vehicle 102.

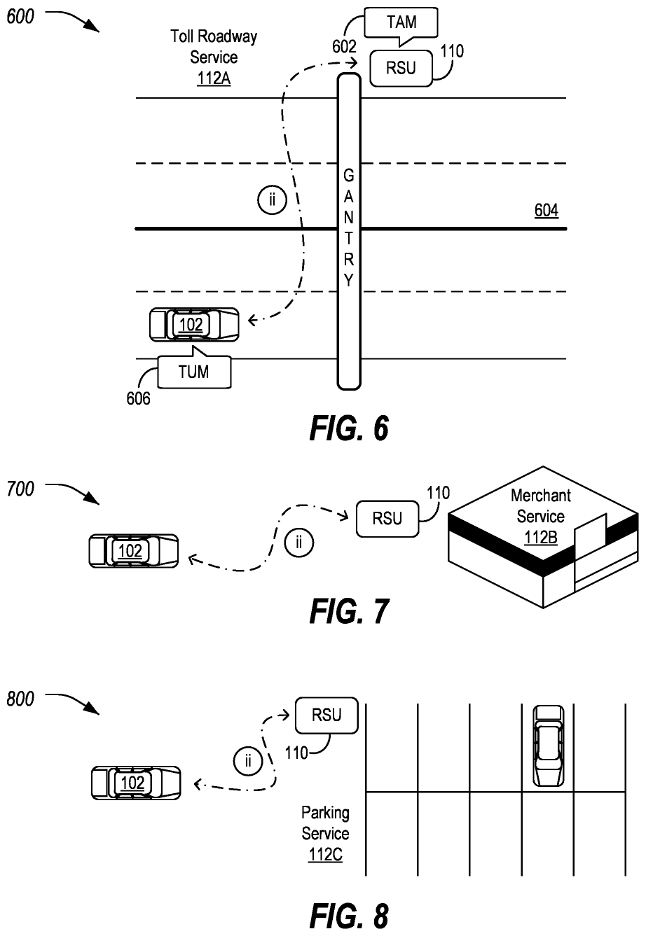

At index (E), the vehicle 102 prepares a service request 206 to send to the backend management service 114. The service request 206 may include a request for use of the features of the service 112. Some non-limiting examples of the services 112 may include toll roads as shown in FIG. 6, merchants as shown in FIG. 7, and parking as shown in FIG. 8. The service request 206 may include the vehicle public key 202. The vehicles 102 may maintain the vehicle private key 204 in storage at the vehicle 102. At index (F) the service request 206 is sent to the backend management service 114. The service request 206 is received to the backend management service 114 at index (G).

At index (H), the backend management service 114 prepares a certificate bundle 208. The certificate bundle 208 may include information to allow the vehicle 102 to communicate with the service 112. In an example, the certificate bundle 208 may include a service public key 210 and a service private key 212. The service public key 210 and service private key 212 may be an asymmetric key pair generated or otherwise available to the backend management service 114. In some examples, the certificate bundle 208 may include information to allow the vehicle 102 to utilize a single service 112. In other examples, the certificate bundle 208 may include information to allow the vehicle 102 to utilize multiple different services 112 (e.g., two or more of parking, merchant, tolling, etc.).

At index (I), the backend management service 114 encrypts the certificate bundle 208 using the vehicle public key 202. This results in the generation of an encrypted certificate bundle 214 including the service public key 210 and service private key 212. At index (J), the backend management service 114 sends the encrypted certificate bundle 214 to the vehicle 102, which may then be received by the TCU 106 of the vehicle 102.

At index (K), the vehicle 102 decrypts the encrypted certificate bundle 214 using the vehicle private key 204. The service public key 210 and service private key 212 are accordingly kept secure during transmission due to the encryption of the encrypted certificate bundle 214 using the vehicle public key 202. As only the vehicle 102 has access to the vehicle private key 204, intermediaries may be unable to decrypt the service public key 210 and service private key 212 when in transit. At index (L), the information of the certificate bundle 208 is available to the vehicle 102 for use in communicating with the service 112.

FIG. 4 illustrates further details of the generation of the keys that are used to perform the operations discussed herein. As shown in greater detail, the services 112 may be implemented by one or more vendor clouds 402. The vendor cloud 402 may be accessible via the communications network 108 and may provide implementations of the services 112 to the vehicle 102.

Each of the services 112 may be configured to provide a service identity key 404 to the vehicle 102. This service identity key 404 may correspond to the service 112 and, in many, examples, may also be specific to the vehicle 102. In one non-limiting example, each service identity key 404 may include a subset of bits that identify the specific service 112, and a remainder of the bits that identify the specific vehicle 102.

An identity key manager 406 of the vehicle 102 may be configured to be in communication with the vendor cloud 402 over the communications network 108. The identity key manager 406 may be configured to receive the service identity keys 404 from the services 112 using a receiver 408. Responsive to receipt of the service identity keys 404, the identity key manager 406 may be configured to communicate with a HSM 410 of the vehicle 102 to perform operations such as update enrollment of the vehicle 102 with the service 112 and indicate the service identity key 404 to the HSM 410.

The identity key manager 406 may include a generator 412 configured to communicate with the HSM 410 to generate service private keys 416 for the vehicle 102 corresponding to the service identity key 404. The service private keys 416 and service public keys 414 may be keys that are specific to the vehicle 102 for use in accessing the service 112 corresponding to the service identity key 404. The HSM 410 may utilize a private key mapping equation 416 and the service public key 414 from the service identity key 404 for signing the service specific application 420. In an example, the private key mapping equation 416 may be an equation that generates the private key for the HSM 410 algorithmically using the service identity key 404. While the service public key 414 may be based on the generated service private key 416 of the HSM 410, the service public key 414 may also be specific to the service 112 and the vehicle 102. Thus, if the service public key 414 is revoked, the private key of the HSM 410 itself is not revoked and may still be used for other purposes. In some examples, the private key mapping equation 416 may be specific to the service 112, while in other examples the same private key mapping equation 416 may be used across services 112.

An application service manager 418 of the vehicle 102 may be in communication with the identity key manager 406. The application service manager 418 may be configured to allow the identity key manager 406 to identify the correct application 420 of the vehicle 102 to support the operation of the service 112. For instance, the applications 420 may include information indicative of which service identity keys 404 (e.g., the subset of bits that identify the specific service 112) and therefore which services 112 are supported by the respective applications 420. The application service manager 418 may accordingly utilize the service identity key 404 to identify which application 420 (or applications 420) correspond to the service identity key 404.

The vehicle 102 may also communicate with the backend management service 114. This may be performed via the RSU 110 in some example, or directly via cellular over the communications network 108. This may include the receipt of the certificate bundle 208 as discussed above with respect to FIG. 2, as well as the respective certificate enrollment updating as discussed above with respect to FIG. 3. The certificate bundle 208 may include credentials or keys for each different message that may be sent between the vehicle 102 and the service 112. For instance, the vehicle 102 may perform signing 424 of messages sent by the transceiver 426 (e.g., of the TCU 106) using the credentials or keys from the certificate bundle 208, and may perform verification 428 using the credentials or keys for message received by the transceiver 426.

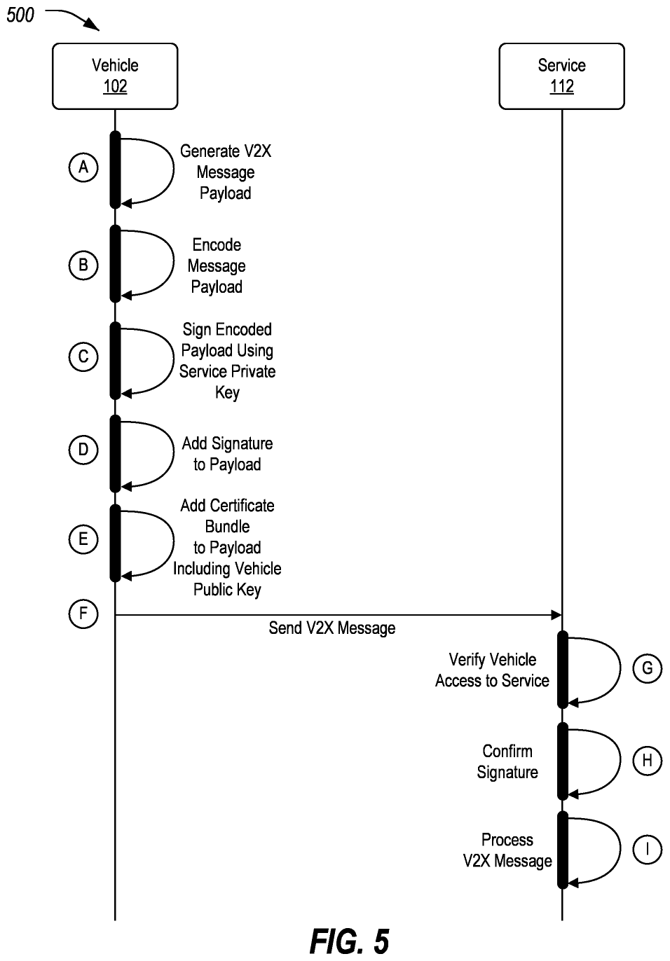

FIG. 5 illustrates an example data flow 500 for the secure channel communication flow (ii) between the vehicle 102 and the service 112. The data flow 500 may be performed, for example, after completion of the data flow 300.

At index (A), the vehicle 102 generates a C-V2X message payload. This message payload may be specific to the operations being performed by the vehicle 102 with the service 112. At index (B), the vehicle 102 encodes the payload. This may be done, in a non-limiting example, using an unaligned packed encoding rules (UPER) encoding. In other examples, other encoding schemes may be used, such as basic encoding rules (BER), distinguished encoding rules (DER), packet encoding rules (PER), octet encoding rules (OER), canonical octet encoding rules (COER), JavaScript Object Notation (JSON), extensible markup language (XML), etc.

At index (C), the vehicle 102 signs the encoded payload using the vehicle private key 204. This service private key 212 may have been received by the vehicle 102 as noted above in the data flow 300. At index (D), the vehicle 102 adds the signature to the payload. At index (E), the vehicle 102 adds a certificate from the certificate bundle 208 to the payload, including the vehicle public key 202. At index (F), the vehicle 102 sends the V2X message including the payload to the service 112. The message is received by the service 112.

At index (G), the service 112 verifies the vehicle 102 has access to the service 112. In an example, the service 112 may receive a certificate revocation list (CRL) from the backend management service 114. For instance, the service 112 may receive the CRL over the backend communication flow (iii) between the RSUs 110 and the backend management service 114. The service 112 may check this CRL to see if the certificate from the received V2X message has been revoked. If so, then the service 112 refuses the vehicle 102 and access to the service 112 is denied.

At index (H), the service 112 confirms the signature in the message payload. In an example, the service 112 verifies the signature using the vehicle public key 202. If the message is confirmed, then at index (I) the service 112 processes the V2X message.

FIG. 6 illustrates an example 600 of the vehicle 102 performing secure channel communication flow (ii) between the vehicles 102 and a RSU 110 of a toll roadway service 112A. The secure channel communication flow (ii) may be performed by the vehicle 102 using the certificate bundle 208 information retrieved using the approach discussed with respect to FIGS. 2-5.

For instance, the vehicle 102 may communicate with the RSU 110 of the toll roadway service 112A. The vehicle 102 may, in an example, receive a toll advertisement message (TAM) 602 from the RSU 110 of the toll roadway service 112A. The TAM 602 may include information to inform the vehicle 102 of the rate for of usage of a roadway 604 controlled by the toll roadway service 112A.

The TAM 602 may include various information useful for a vehicle 102 to understand usage of the roadway 604 controlled by the toll roadway service 112A. This may include fields such as: a timestamp indicative of the time at which the TAM was created or sent, toll types and toll amounts indicative of how the toll information is charged (e.g., based on the toll rate table), a layer type, a layer identifier, an identifier of a payment service to use for payment of the toll, etc. The layer type may be a data element used to uniquely identify a type of information to be found in a layer of a geographic map fragment such as an intersection. The layer identifier may correspondingly be an identifier of map information.

The TAM 602 may also include map information indicative of the layout of the roadway 604, such as an intersection geometry list and a road segment list. The road segment list may include various properties of the roadway, including lane description, high occupancy status, and so on. This information may include, for instance, indications of the layout of the lanes of the roadway 604, which may be used to allow vehicles 102 to identify when a tolled area is approached, as well as in which lane the vehicle 102 is traveling.

For instance, the TAM 602 may define one or more trigger node points that may collectively define the boundaries of a trigger zone. Further aspects of map data and other details of message elements described herein are further defined in the J2735 standard DSRC Message Set Dictionary™, published by Society of Automotive Engineers (SAE) International, the standard being incorporated herein by reference in its entirety.

Responsive to the vehicle 102 reaching the location, the TCU 106 of the vehicle 102 may generate a toll usage message (TUM) 606. The TUM 606 includes various information provided by vehicles 102 to RSUs 110 that indicates usage of the roadway 604 by the vehicle 102. This information may include fields such as a message count that indicates a unique number of the TUM 606 for the transaction. The message count may be used to help in identifying if any packet loss has occurred. The TUM 606 may also include a unique random identifier that may be used as a temporary account identifier or tag to track the transaction of messaging between the vehicle 102 and the broadcast message interface of the RSU 110, while preserving relative anonymity of the vehicle 102.

The TUM 606 may also include information about the vehicle 102 entry to the toll area. For instance, the TUM 606 may include a timestamp the time when the TUM 606 was created, latitude, longitude, and elevation of the vehicle 102, positional accuracy of the latitude, longitude, and elevation, speed of the vehicle 102, and heading of the vehicle 102. The TUM 606 may also include other information, such as type of the vehicle 102, an identifier of the toll payment center. The identifiers may be globally unique identifiers (GUIDs), to allow the payment service for the roadway 604 to be uniquely identified. The TUM 606 may also include an intersection identifier of the intersection through which the vehicle 102 entered the roadway 604, where the intersection identifier was received by the vehicle 102 in the TAM 602 (e.g., via the intersection geometry list and/or road segment list). The TUM 606 may also include a charge amount for the travel in the tolled area as determined by the vehicle 102 using the information in the TAM 602. Other information may also be included in the TUM 606, such as the distance traveled by the vehicle 102, a number of passengers in the vehicle 102, and a license plate number or other identifier of the vehicle 102.

The TCU 106 may send the TUM 606 to the RSU 110. In one example, the TUM 606 may be encoded with a key and/or signed using a certificate, and the RSU 110 may utilize a key or other information to decrypt and/or confirm the sender of the TUM 606 as being the TCU 106. The RSU 110 may forward the TUM 606 to a payment center to complete the transaction.

FIG. 7 illustrates an example 700 of the vehicle 102 performing secure channel communication flow between the vehicles 102 and a RSU 110 of a merchant service 112B. Similar to the example 600, in the example 700 the vehicle 102 communicates V2X messages with the RSU 110 of the merchant service 112B to perform a purchase from the merchant service 112B.

FIG. 8 illustrates an example 800 of the vehicle 102 performing secure channel communication flow between the vehicles 102 and a RSU 110 of a parking service 112C. Similar to the examples 600 and example 700, in the example 800 the vehicle 102 communicates V2X messages with the RSU 110 of the parking service 112C to pay for parking from the parking service 112C.

As noted above, a CRL may be provided from the backend management service 114 to the services 112 to allow the services 112 to identify when vehicles 102 have been unsubscribed from the services 112. The un-subscription may be initiated, in an example, by a vehicle 102 switching service providers from one service 112 to another. Or, in another example, the un-subscription may result from the service 112 removing the vehicle 102 for non-payment or another issue. Regardless, as the vehicle 102 may use different keys and certificate bundles 208 for different services, the vehicle 102 may be able to un-subscribe from one service 112 without affecting vehicle 102 subscriptions to other services 112.

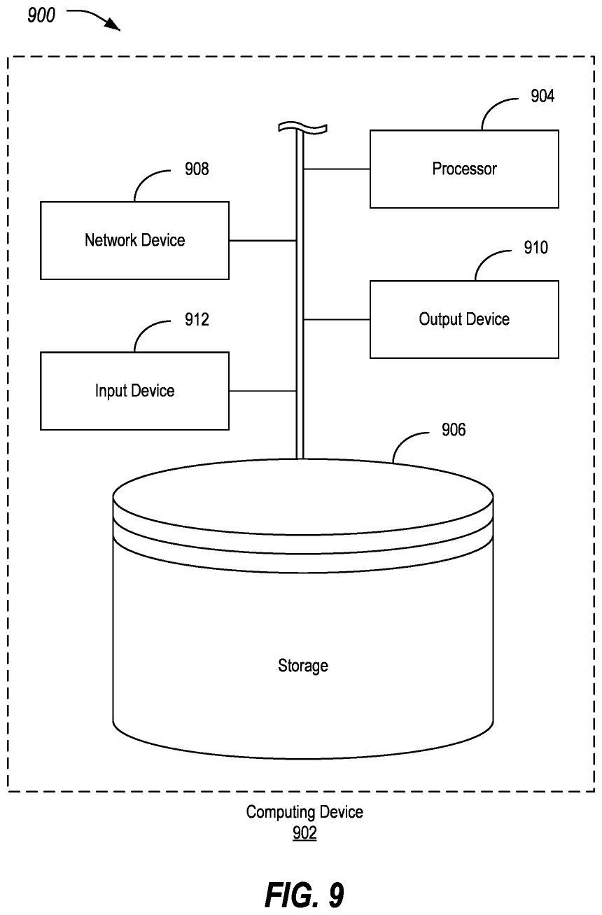

FIG. 9 illustrates an example 900 of a computing device 902. Referring to FIG. 9, and with reference to FIGS. 1-8, the TCU 106, RSU 110, and backend management service 114 may be examples of such computing devices 902. As shown, the computing device 902 may include a processor 904 that is operatively connected to a storage 906, a network device 908, an output device 910, and an input device 912. It should be noted that this is merely an example, and computing devices 902 with more, fewer, or different components may be used.

The processor 904 may include one or more integrated circuits that implement the functionality of a central processing unit (CPU) and/or graphics processing unit (GPU). In some examples, the processors 904 are a system on a chip (SoC) that integrates the functionality of the CPU and GPU. The SoC may, optionally, include other components such as, for example, the storage 906 and the network device 908 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families.

Regardless of the specifics, during operation the processor 904 executes stored program instructions that are retrieved from the storage 906. The stored program instructions, accordingly, include software that controls the operation of the processors 904 to perform the operations described herein. The storage 906 may include both non-volatile memory and volatile memory devices. The non-volatile memory includes solid-state memories, such as negative-AND (NAND) flash memory, magnetic and optical storage media, or any other suitable data storage device that retains data when the system 100 is deactivated or loses electrical power. The volatile memory includes static and dynamic random-access memory (RAM) that stores program instructions and data during operation of the system 100.

The GPU may include hardware and software for display of at least two-dimensional (2D) and optionally three-dimensional (3D) graphics to the output device 910. The output device 910 may include a graphical or visual display device, such as an electronic display screen, projector, printer, or any other suitable device that reproduces a graphical display. As another example, the output device 910 may include an audio device, such as a loudspeaker or headphone. As yet a further example, the output device 910 may include a tactile device, such as a mechanically raiseable device that may, in an example, be configured to display braille or another physical output that may be touched to provide information to a user.

The input device 912 may include any of various devices that enable the computing device 902 to receive control input from users. Examples of suitable input devices that receive human interface inputs may include keyboards, mice, trackballs, touchscreens, voice input devices, graphics tablets, and the like.

The network devices 908 may each include any of various devices that enable the TCU 106, RSU 110, and backend management service 114 to send and/or receive data from external devices over networks (such as the communications network 108). Examples of suitable network devices 908 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle for secure service registration, comprising:
a transceiver; and
a controller programmed to utilize the transceiver to:
establish a secure connection with a management system,
send a service request to access a vehicle-to-everything (V2X) service to the management system, the service request including a vehicle public key of a vehicle public/private key pair,
receive, from the management system, a certificate bundle encrypted using the vehicle public key, the certificate bundle including a service public/private key pair and a certificate for accessing the V2X service,
decrypt the certificate bundle using a vehicle private key corresponding to the vehicle public key, and
utilize the service public/private key pair and the certificate to access the V2X service.

2. The vehicle of claim 1, wherein the vehicle public/private key pair is specific to the V2X service, and wherein the controller is further programmed to generate the service-specific vehicle public key and the service-specific vehicle private key using a service identity key mapping module.

3. The vehicle of claim 1, wherein the controller is further programmed to:
generate a V2X message payload to deliver to the V2X service;
sign the V2X message payload using the service private key; and
send the V2X message payload as signed to the V2X service.

4. The vehicle of claim 3, further comprising including the certificate bundle and the vehicle public key in the V2X message payload.

5. The vehicle of claim 1, wherein the V2X service is a toll roadway.

6. The vehicle of claim 1, wherein the V2X service is a merchant.

7. The vehicle of claim 1, wherein the V2X service is parking for the vehicle.

8. A system for secure service registration, comprising:
a management system programmed to
receive, from a vehicle, a service request to access a vehicle-to-everything (V2X) service, the service request including a vehicle public key of a vehicle public/private key pair;
prepare a certificate bundle including a service public/private key pair and a certificate for accessing the V2X service;
encrypt the certificate bundle using the vehicle public key; and
transmit the certificate bundle, as encrypted, to the vehicle responsive to the service request.

9. The system of claim 8, wherein the management system is further programmed to:
receive an indication to revoke the certificate; and
send the V2X service a certificate revocation list including the certificate as revoked.

10. The system of claim 9, wherein the indication to revoke the certificate is received from the vehicle.

11. The system of claim 9, wherein the indication to revoke the certificate is received from the V2X service, wherein the revoke of the certificate does not affect other service public/private key pairs for other V2X services.

12. A method for secure service registration, comprising:
establishing a secure connection between a vehicle and a management system;
sending a service request to access a vehicle-to-everything (V2X) service to the management system, the service request including a vehicle public key of a vehicle public/private key pair;
receiving, from the management system, a certificate bundle encrypted using the vehicle public key, the certificate bundle including a service public/private key pair and a certificate for accessing the V2X service;
decrypting the certificate bundle using a vehicle private key corresponding to the vehicle public key; and
utilizing the service public/private key pair and the certificate to access the V2X service.

13. The method of claim 12, wherein the vehicle public/private key pair is specific to the V2X service, and further comprising generating the service-specific vehicle public key and the service-specific vehicle private key using a service identity key mapping module.

14. The method of claim 12, further comprising:
generating a V2X message payload to deliver to the V2X service;
signing the V2X message payload using the service private key; and
sending the V2X message payload as signed to the V2X service.

15. The method of claim 14, further comprising including the certificate bundle and the vehicle public key in the V2X message payload.

16. The method of claim 12, wherein the V2X service is a toll roadway.

17. The method of claim 12, wherein the V2X service is a merchant.

18. The method of claim 12, wherein the V2X service is parking for the vehicle.

19. The method of claim 12, further comprising:
preparing, by the management system, the certificate bundle including the service public/private key pair and the certificate for accessing the V2X service;
encrypting the certificate bundle using the vehicle public key; and
transmitting the certificate bundle, as encrypted, to the vehicle responsive to the service request.

20. The method of claim 19, further comprising:
receiving, to the management system, an indication to revoke the certificate; and
sending, from the management system to the V2X service, a certificate revocation list including the certificate as revoked, wherein the revoking of the certificate does not affect other service public/private key pairs for other V2X services.
